(19) United States
(12) Patent Application Publication
(10) Pub. No.: US 2014/0316972 A1
(43) Pub. Date: Oct. 23, 2014

(54) E-COMMERCE SYSTEM AND A METHOD FOR ACHIEVING

(71) Applicant: Dongsheng Yan, Tianjin (CN)

(72) Inventor: Dongsheng Yan, Tianjin (CN)

(21) Appl. No.: 14/322,847

(22) Filed: Jul. 2, 2014

(30) Foreign Application Priority Data
Dec. 11, 2013 (CN) 2013106721555

(51) Int. Cl. G06Q 40/04

(52) U.S. Cl. CPC G06Q 40/04
USPC 705/37

(57) ABSTRACT

An e-commerce system and a method for realizing spot transaction of commodity. The present invention includes user-level apparatus, transmission level apparatus, the access level apparatus and service level apparatus, wherein the user level apparatus includes a user end device, a storage unit and a bank unit; the transmission level apparatus includes the Internet and a private network; the access level apparatus includes a user interface unit, an information query release interface unit, a storage interface unit, a bank interface unit, and an information query interface unit; the service level apparatus includes a common data channel unit, a transaction server, a settlement server, an information management server, a data settlement server, a server sequence controller and a data server. The server sequence controller of the present invention controls the transaction server, the settlement server and the data settlement server, which forms a specific working sequence period, realizes spot transaction of commodity and daily delivery in kind, and enables the real function of spot trading of commodity via an e-commerce system.

### CROSS-REFERENCE TO RELATED APPLICATION

This application claims priority to Chinese Application No. 2013106721555 filed on Dec. 11, 2013, the entire content is incorporated herein by reference in its entirety.

### TECHNICAL FIELD

The disclosure relates to data processing devices and methods used in the e-commerce technical field, and more specifically, relates to a device and a method for realizing spot transaction of staple commodities.

### BACKGROUND

Information technology and Internet are becoming more and more popular. Information-based e-commerce is gradually developing. Information based e-commerce method may utilize Internet as a tool and enable different business and trade activities between sellers and buyers who may never meet each other in person. As a new way of transaction, manufactures, transportation corporations and consumers are no longer confined by territories.

Systems in current market may implement e-commerce by accessing Internet. To some degree, current systems may realize automatic processing of trade, improve commodity trading efficiency and solve user information and trading information identification. However, current systems and methods may implement individual trading modes between commodity suppliers and consumers and may not meet the needs of large scale of trading among vast amount of suppliers, traders and consumers.

### BRIEF SUMMARY

The present invention provides an e-commerce system and a method for realizing spot transaction of commodity against the defects in the prior art e-commerce system and method. The system may be used in a WAN such as Internet. Meanwhile, it provides telecommunication processes during which secretes are highly protected. It also provides means of access with abundant functions. It connects traders, storage databases and bank databases, collects dealing information of both parties participated in a transaction. With the aid of network interconnection apparatus, and by means of information collection and processing, the system enables traders to complete the entire trading procedure in a quick, safe and convenient way. In particular, this system adopts many-to-many concentrated transaction mode and realizes spot transaction of commodity through special computing units and processing sequences. It may realize daily delivery in kind and satisfies the demand of real trading between a seller and a buyer.

The present invention provides an e-commerce system and a method for realizing spot transaction of staple commodities. The system includes user-level apparatus, transmission level apparatus, access level apparatus and service level apparatus. One end of the user-level apparatus is connected to one end of the transmission level apparatus. The other end of the transmission level apparatus is connected to one end of the access level apparatus. The other end of the access level apparatus is connected to the service level apparatus.

The user level apparatus includes a user terminal device (19). The transmission level apparatus includes a WAN (22) and a private network (23). The access level apparatus includes a user interface (10) and a bank interface (13). The service level apparatus includes a common data channel (14), a transaction server (15), an information management server (17) and a data server (18).

### BRIEF DESCRIPTION OF THE DRAWINGS

Having thus described some embodiments in general terms, reference will now be made to the accompanying drawings, which are not necessarily drawn to scale. The embodiments illustrated in the figures of the accompanying drawings herein are by way of example and not by way of limitation, and wherein:

FIG. 1 is a schematic diagram of a spot transaction device and system in accordance with exemplary embodiments of the disclosure;

FIG. 2 is a schematic diagram of a user terminal device in the spot transaction system in accordance with exemplary embodiments of the disclosure;

FIG. 3 is a schematic diagram of a user interface device in the spot transaction system in accordance with exemplary embodiments of the disclosure;

FIG. 4 is a schematic diagram of an information query release device in the spot transaction system in accordance with exemplary embodiments of the disclosure;

FIG. 5 is a schematic diagram of a storage interface device in the spot transaction system in accordance with exemplary embodiments of the disclosure;

FIG. 6 is a schematic diagram of a bank interface device in the spot transaction system in accordance with exemplary embodiments of the disclosure;

FIG. 7 is a schematic diagram of a common data channel in the spot transaction system in accordance with exemplary embodiments of the disclosure;

FIG. 8 is a schematic diagram of a transaction server in the spot transaction system in accordance with exemplary embodiments of the disclosure;

FIG. 9 is a schematic diagram of a settlement server in the spot transaction system in accordance with exemplary embodiments of the disclosure;

FIG. 10 is a schematic diagram of an information management server in the spot transaction system in accordance with exemplary embodiments of the disclosure;

FIG. 11 is a schematic diagram of a data settlement server in the spot transaction system in accordance with exemplary embodiments of the disclosure;

FIG. 12 is a schematic diagram of a server sequence controller in the spot transaction system in accordance with exemplary embodiments of the disclosure;

FIG. 13 is a schematic diagram of procedural control of a server sequence controller in the spot transaction system in accordance with exemplary embodiments of the disclosure

FIG. 14 is a data flow chart for electronic contract signature in a spot transaction system in accordance with exemplary embodiments of the disclosure;

FIG. 15 is a flow chart illustrating an electronic contract signature in a spot transaction system in accordance with exemplary embodiments of the disclosure;

FIG. 16 is a data flow chart illustrating an electronic contract transfer in a spot transaction system in accordance with exemplary embodiments of the disclosure;

FIG. 17 is a flow chart illustrating an electronic contract transfer in a spot transaction system in accordance with exemplary embodiments of the disclosure;

FIG. 18 is a flow chart illustrating an electronic contract in a spot transaction system in accordance with exemplary embodiments of the disclosure;

FIG. 19 is a flow chart illustrating an electronic contract performance in a spot transaction system in accordance with exemplary embodiments of the disclosure;

FIG. 20 is a flow chart illustrating query steps in a spot transaction system in accordance with exemplary embodiments of the disclosure;

FIG. 21 is a schematic diagram illustrating implementing a spot transaction by a server sequence controller in accordance with exemplary embodiments of the disclosure; and

FIG. 22 is a flow chart illustrating running sequence of a server group in a spot transaction system in accordance with exemplary embodiments of the disclosure.

### DETAILED DESCRIPTION OF THE EMBODIMENTS

The embodiments of the present invention are specified below and are implemented on the basis of the technical solution of the present invention. The embodiments provide detailed means of implementation and specific operation procedures. However, the protection scope of the present invention is not limited to the embodiments hereunder.

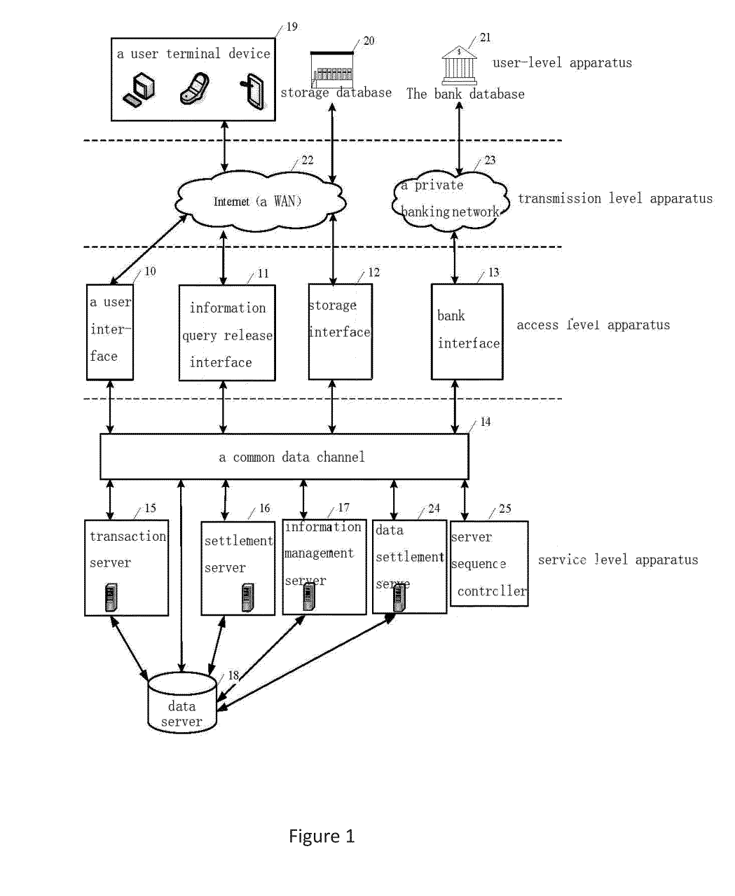

FIG. 1 is a schematic diagram of a spot transaction system 100 in accordance with exemplary embodiments of the disclosure. The spot transaction system 100 may comprise a network configuration in accordance with an exemplary embodiment of the present disclosure. User data may be input via a user terminal device (19). The user terminal device (19) may be connected to a user interface (10) via a WAN (Wide Area Network) (22). A storage database (20) may also be connected to a storage interface (12) via the WAN (22). An information query release interface (11) may release data and information to the public via the WAN (22). A bank database (21) is connected to a bank interface (13) via a bank private network (23). The user interface (10), the information query release interface (11), the storage interface (12) and the bank interface (13) may individually and respectively connected to a transaction server (15), a settlement server (16), an information management server (17) and a data server (18), a data settlement server (24), and a server sequence controller (25), via a common data channel (14) to implement data processing and storage.

The spot transaction system 100 may be a user level apparatus, a transmission level apparatus, an access level apparatus and/or a service level apparatus.

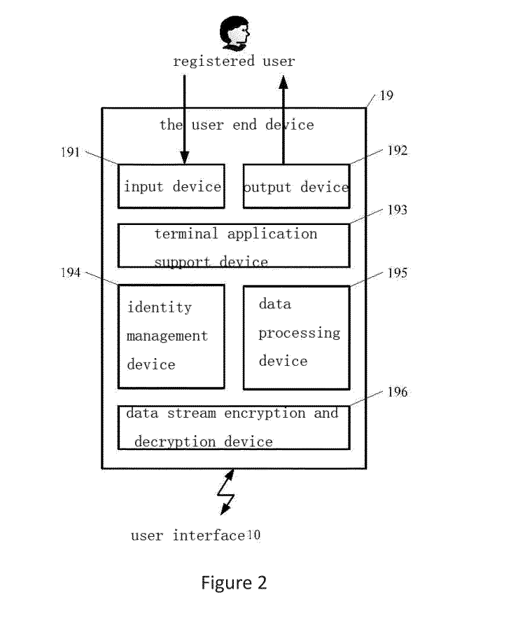

FIG. 2 is a schematic diagram of the user terminal device (19) in the spot transaction system 100 in accordance with exemplary embodiments of the disclosure. The user terminal device (19) may comprise an input device (191), an output device (192), a terminal application support device (193), an identity management device (194), a data processing device (195) and a data stream encryption and a decryption device (196). The input device (191) may be a keyboard, a mouse, a touch screen, a mobile phone or any other input devices. The output device (192) may be a display, a touch screen, a mobile screen or any other output devices. The terminal application support device (193) may enable the user terminal device (19) to be implemented in a standard personal computer, a smart phone, a panel computer or any other terminal devices. It may be similar to a terminal adapter converter. The identity management device (194) authenticates users' identities. The data processing device (195) may implement a query result data processing and display data on the output device (192). The data stream encryption and decryption device (196) may encrypt and decrypt data received by and sent from the user terminal device (19) and thereby enhancing security of the system.

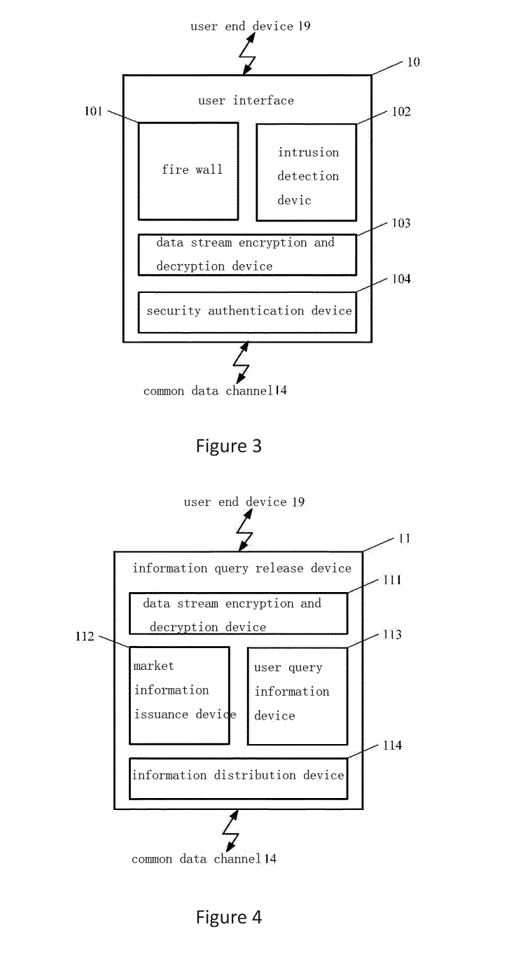

FIG. 3 is a schematic diagram of the user interface device (10) in the spot transaction system 100 in accordance with exemplary embodiments of the disclosure. The user interface device (10) may comprise a fire wall (101), an intrusion detection device (102), a data stream encryption and decryption device (103), and a security authentication device (104).

The fire wall (101) may effectively prevent hack and/or invasions. The fire wall (101) may be established between different networks or different network security domains. By monitoring, restricting and directing data streams across the fire wall (101), the fire wall (101) may prevent inside information, structure and operation conditions from being accessed by outsiders thus protecting the network security. The intrusion detection device (102) may be an addition to the fire wall (101) to strengthen the firewall (101). The intrusion detection system (102) may collect and analyze information from key points of the network or the system and identify actions violating safe policies or actions of attacking the system. The data stream encryption and decryption device (103) may encrypt and decrypt data sent and received, thereby enhancing the system's security. The data stream encryption and decryption device (103) may work with an encryption and decryption device in interfaces and guarantee safe transmission of user information in the WAN. Electronic identity authentication may be used to guarantee that all the data to be transmitted is encrypted to meet requirements of secured transmission of confidential and sensitive information. The security authentication device (104) authenticates security of information and manages security of communication link in the WAN environment. The security authentication device (104) may enable the user terminal devices of registered users to securely access the WAN according to collected network information of the user terminal devices of the registered users and the security policy.

FIG. 4 is a schematic diagram of the information query release device (11) in the spot transaction system in accordance with exemplary embodiments of the disclosure. The information query release device (11) may comprise a data stream encryption and decryption device (111), a market information issuance device (112), a user query information device (113), and an information distribution device (114).

The data stream encryption and decryption device (111) may encrypt and decrypt the data sent and received, thereby enhancing the system's security. The market information issuance device (112) may release market information of the system. The market information may be disclosed in a standard format. Therefore, user buying and selling queue information, transaction information and other information may be edited into the standard format and disclosed in the standard format. The disclosed information may be acquired at a user end, a web site, a private market display software through TCP/IP protocol. Users may acquire the disclosed information in a fast manner in multi-channels. The user query information device (113) enables user to check information such as open interest and funds, etc. User information may comprise user private information and therefore may not be transmitted via the market information issuance device (112). Instead, user's private information may be encrypted and then transmitted to the user terminal device directly, allowing the user to keep track of his/her transactions in real time. The information distribution device (114) distributes and forwards market information and user query information. The information distribution device (114) distributes data between the market information issuance device (112) and the user query information device (113) based on types of information to be disclosed.

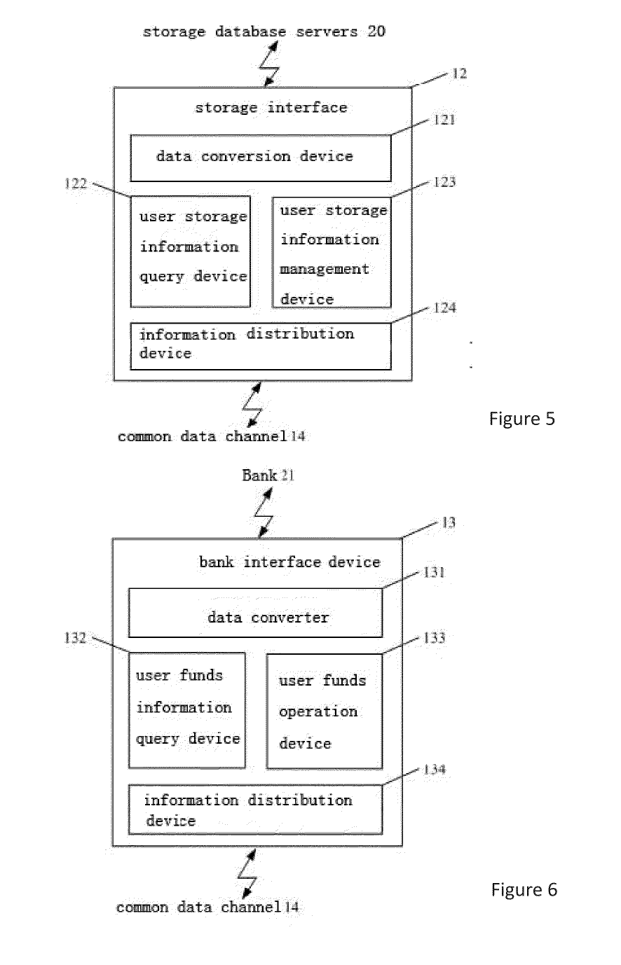

FIG. 5 is a schematic diagram of the storage interface device (12) in the spot transaction system in accordance with exemplary embodiments of the disclosure The storage interface device (12) may comprise a first data conversion device (121), a user storage information query device (122), a user storage information management device (123) and an information distribution device (124).

The first data conversion device (121) may enable one docking system to work with another docking system although the docking systems may use different data formats. Since each storage system may have their inventory saved in a different data format, the present invention defines a unified internal format. The first data conversion device (121) of the storage interface unifies data streams accessing from different storages into the unified internal format for communication with the internal system. User storage information query device (122) may be configured to check storage status, such as track cargo storage and status of cargoes, etc. Cargo information acquired by the user storage information query device (122) may indicate source of the cargo and may be used for implementing contract between sellers and buyers. The user storage information management device (123) may operate on storage information or update status of the storage information, such as submitting a storage receipt and/or distributing a storage receipt. The user storage information management device (123) may process and update users' storage information according to users' incoming and outgoing cargo information. The information distribution device (124) may distribute and forward user storage query information and user storage management information.

FIG. 6 is a schematic diagram of the bank interface device (13) in the spot transaction system in accordance with exemplary embodiments of the disclosure. The bank interface device (13) may comprise a second data conversion device (131), a user funds information query device (132), a user funds operation device (133), and an information distribution device (134).

The second data conversion device (131) may enable different banks to work with the spot transaction system although different banks may use different data formats. Due to the different formats of different banks, the present invention defines a unified internal bank format. The second data conversion device (131) may convert data streams received from each bank into an internal format. By conversion, communication with the spot transaction system may use internal format regardless of what data format is used by each bank. The user funds information query device (132) may check information of a user's bank account, such as user's right and benefit, balance, etc. User account information acquired by user funds information query device (132) may indicate source of the funds and may be used for implementing contract between sellers and buyers. The user funds operation device (133) may process and update information of user's bank account, such as incoming and outgoing funds. User funds information may be updated at bank end according to the incoming and outgoing funds of the bank account. The information distribution device (134) may distribute and forward user funds information and user funds operation information.

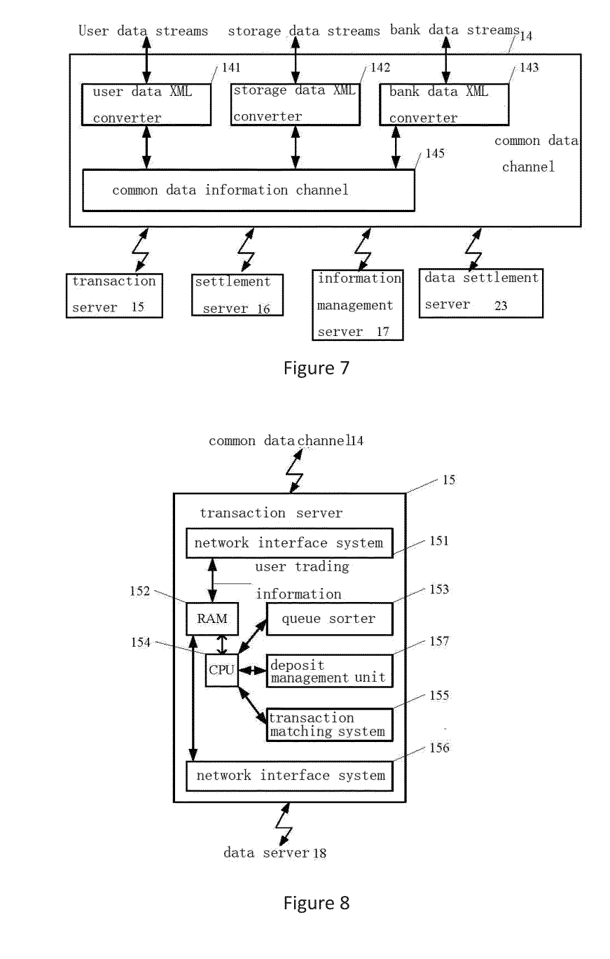

FIG. 7 is a schematic diagram of the common data channel (14) in the spot transaction system in accordance with exemplary embodiments of the disclosure. User data streams may be converted to a unified XML data format through a user data XML converter (141); storage data streams are converted to the unified XML data format through a storage data XML converter (142); and bank data streams are converted to the unified XML data format through a bank data XML converter (143). Data exchange may be implemented by XML. The XML data format in application may comprise desired data content, thereby reducing the amount of data streams, improving unification of user information. By converting various data into XML data format, server may execute tasks generated by XML and then generate XML data needed by each application. Converting different types of data format into XML data format may enable fast response to a user's request and reduce burden of the server. The unified user data streams, storage data streams and bank data streams may be restructured and associated with each other in a data information association system (144) according to their respective identification code (such as user identity information, etc.), thereby reducing processing time by the server and the times of data transmission between servers. The data streams may be distributed and forwarded via a common data information channel (145). By using the common data information channel (145), data streams may be assigned and transferred to different servers based on needs of different servers. By doing so, loads are may be balanced for adapting to the distributed computing environment.

FIG. 8 is a schematic diagram of a transaction server (15) in the spot transaction system in accordance with exemplary embodiments of the disclosure. The transaction server (15) may comprise a network interface system (151), a random access memory (RAM) (152), a queue sorter (153), a central processing unit (CPU) (154), a transaction matching system (155), a network interface system (156), and a deposit management unit (157).

The random access memory (RAM) (152) is connected to the central processing unit (154) for high speed information storage. User trading information may be processed directly in the RAM to accelerate the processing speed by a transaction server. The network interface system (151) and the network interface system (156) may be respectively connected to the random access memory (RAM) (152) to transfer information between the transaction server (15) and the common data channel (14) and the data server (18). The queue sorter (153) may be connected to the central processing unit (CPU) (154) to put user electronic contract signature and information desired to be transferred in the queue waiting for processing. The transaction matching system (155) may be connected to the central processing unit (CPU) (154) for matching transactions waiting in the queue. A distributed deployment mode may be adopted between the queue sorter (153) and the transaction matching system (155) to enable an employment of a proprietary communications protocol between the queue sorter (153) and the transaction matching system (155).

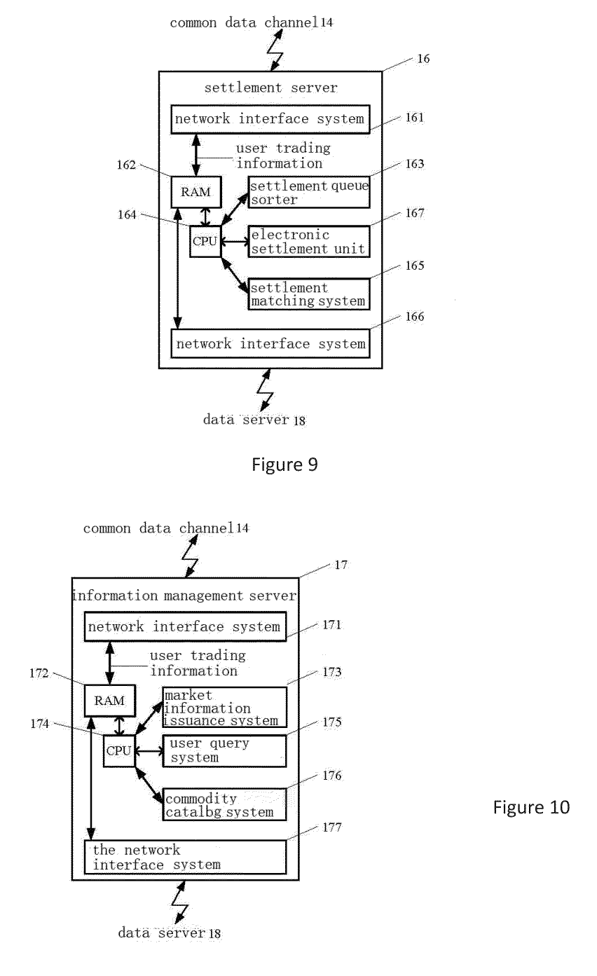

FIG. 9 is a schematic diagram of the settlement server (16) in the spot transaction system in accordance with exemplary embodiments of the disclosure. The settlement server (16) may comprise a network interface system (161), a random access memory (RAM) (162), a settlement queue sorter (163), a central processing unit (CPU) (164), a settlement matching system (165), and a network interface system (166).

The random access memory (162) may be connected to the central processing unit (CPU) (164) for high speed information storage. User trading information may be processed directly in the RAM to accelerate the processing speed by a transaction server. The network interface system (161) and the network interface system (166) may be respectively connected to the random access memory (RAM) (162) to transfer information between the transaction server (15) and the common data channel (14) and the data server (18). The settlement queue sorter (163) may be connected to the central processing unit (CPU) (164) to put user electronic contract signature and information desired to be transferred in the queue waiting for processing. The settlement matching system (165) may be connected to the central processing unit (CPU) (164) for matching transactions waiting in the queue. A distributed deployment mode may be adopted between the settlement queue sorter (163) and the settlement matching system (165) to enable an employment of a proprietary communications protocol between the settlement queue sorter (163) and the settlement matching system (165).

FIG. 10 is a schematic diagram of the information management server (17) in the spot transaction system in accordance with exemplary embodiments of the disclosure. The information management server (17) may comprise a network interface system (171), random access memory (RAM) (172), a market information issuance system (173), a central processing unit (CPU) (174), a user query system (175), a commodity catalog system (176), and network interface system (177).

The random access memory (RAM) (172) may be connected to the central processing unit (CPU) (174) for high speed information storage. User trading information may be processed directly in the RAM to accelerate the processing speed by a transaction server. The network interface system (171) and the network interface system (177) may be respectively connected to the random access memory (RAM) (172) to transfer information between the transaction server (17) and the common data channel (14) and the data server (18). The market information issuance system (173) may be connected to the central processing unit (CPU) (174) to regularly detect updating the market data, prepare disclosing of the market data and put the information of current transaction and settlement in the queue and transfer the information to the user terminal device and information release interface. The user query system (175) may be connected to the central processing unit (CPU) (174) to regularly detect updating the user information and timely respond to a user's query to prepare for information query and release, and direct transaction results to a user terminal device and information release interface. The commodity catalog system (176) may be connected to the central processing unit (CPU) (174) and may be stored in a predefined standard contract list which may be used for future transaction, so as to implement the management to commodity attributions and parameters.

FIG. 11 is a schematic diagram of the data settlement server (23) in the spot transaction system in accordance with exemplary embodiments of the disclosure. The data settlement server (23) may comprise a network interface system (231), a random access memory (RAM) (232), an extended settlement compensation management unit (233), a central processing unit (CPU) (234), checkout processing unit (235) and a network interface system (236).

The data settlement server (23) may be connected to the database (18) for calculating and verifying fund saved in the database (18). The checkout processing unit (235) may directly process data saved in the RAM to accelerate the processing speed by a transaction server. The extended settlement compensation funds management unit (233) may determine compensation for sellers or buyers. For example, when buyer's purchasing request is not satisfied, namely, the buyer wants to purchase contracts more than those provided by sellers, the buyer may get compensation from sellers who did not submit all of their selling contracts. Similarly, if a seller's selling request is not satisfied, namely, the seller wants to sell contracts more than those purchased by buyers, the seller may get compensation from buyers who did not submit all of their purchasing contracts.

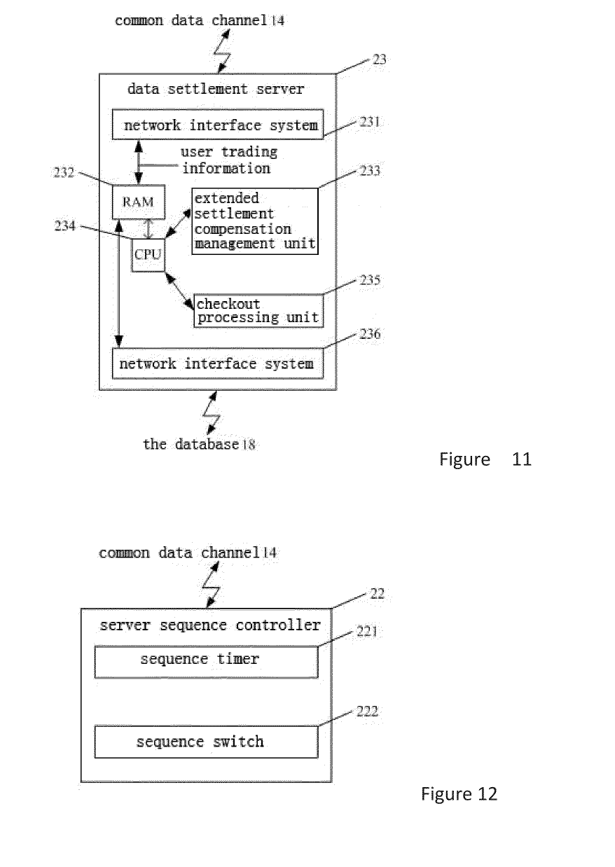

FIG. 12 is a schematic diagram of the server sequence controller (22) in the spot transaction system in accordance with exemplary embodiments of the disclosure. The server sequence controller (22) may comprise a sequence timer (221) and a sequence switch (222).

The server sequence controller (22) may be connected to the transaction server (15), the settlement server (16), the information management server (17) and the data settlement server (23) to manage and control the working sequence. The sequence timer (221) may generate server running sequence period. The sequence switch (222) may transmit a server status switching signal based on the server running sequence period. The sequence switch (222) may generate a control signal and send the control signal based on server running sequence period to control the operation status of the server.

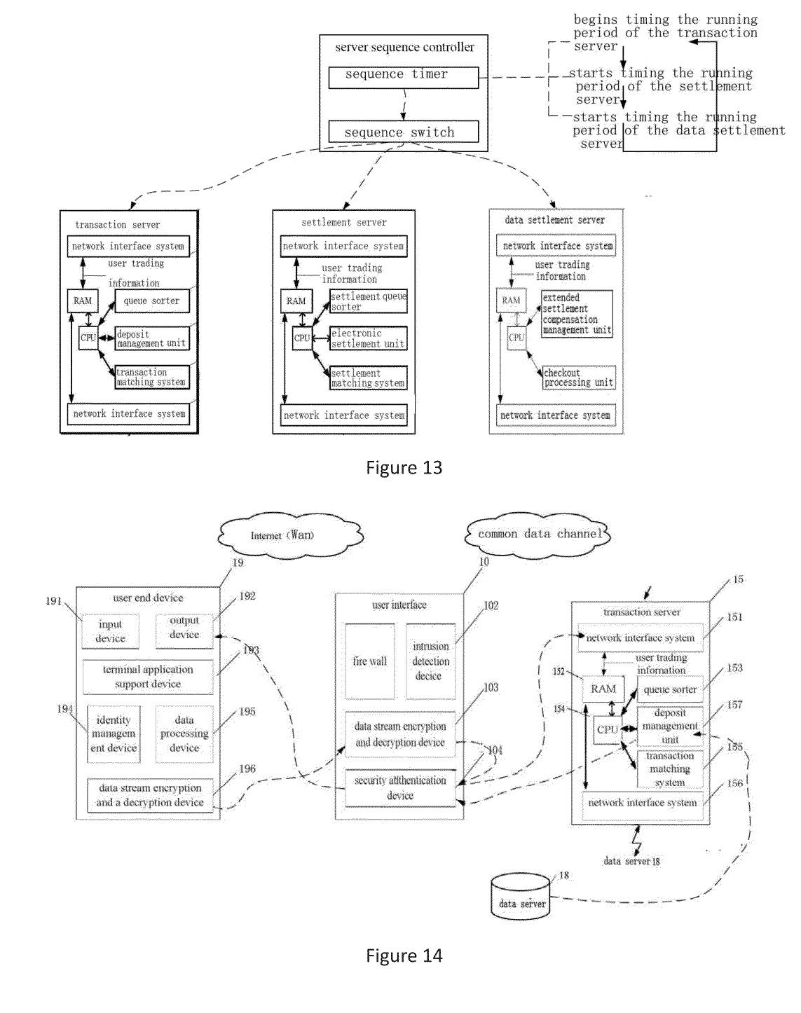

FIG. 13 is a schematic diagram of procedural control of the server sequence controller (22) in the spot transaction system in accordance with exemplary embodiments of the disclosure.

When a control method starts, the server sequence controller (22) sends a transaction starting control signal to start the method of controlling the transaction server (15). A sequence timer (221) may time running period of the transaction server (15). Control signals are transmitted via the internal network to the transaction server (15) to control operation status of the transaction server (15).

When the sequence timer (221) stops timing the running period of the transaction server (15), a termination signal may be sent to the transaction server (15) via the internal network to terminate the operation of the transaction server (15). A settlement starting control signal may be sent to the settlement server (16) via the internal network. The sequence timer (221) may time the running period of the settlement server (16). Control signals may terminate operation of the transaction server (15) and start operation of the settlement server (16).

When the sequence timer (221) stops timing the running period of the settlement server (16), a termination signal may be sent to the settlement server (16) via the internal network to terminate the operation of the settlement server (16). A data settlement starting control signal may be sent to the data settlement server (23) via the internal network. The sequence timer (221) may time the running period of the data settlement server (23). Control signals may terminate operation of the settlement server (16) and start operation of the data settlement server (23).

When the sequence timer (221) stops timing the running period of the data settlement server (23), a termination signal may be sent to the data settlement server (23) via the internal network. A transaction starting control signal may be sent to the transaction server (15) via the internal network. The sequence timer (221) may time the running period of the transaction server. Control signals may terminate operation of the data settlement server (23) and start operation of the transaction server (15).

FIG. 14 is a data flow chart for electronic contract signature in a spot transaction system in accordance with exemplary embodiments of the disclosure.

When a transaction starts, a window may be displayed on the user terminal device (19) for user to input user ID and password. When a registered user's identity information is input, the data stream encryption and decryption device (196) may encrypt the input information. The encrypted information may be transmitted to the user interface (10) via the WAN (22) and decrypted by the data stream encryption and decryption device (103). The decrypted result is sent to the security authentication device (104) for authentication. When identity information is received on the user terminal device (19), the security authentication device (104) may derive the user identity information from the data server (18) via the internal network.

The security authentication device (104) compares the password received on the user terminal device (19) and the password saved in the data server (18). A control signal may be fed back to the user terminal device (19) via the WAN (22) after authentication. The control signal may display a message on the user terminal device (19) notifying the user that the authentication has been passed and provide operations available for user's selection. The user's communication link in WAN with the user identity information is saved in the security authentication device (104) to facilitate fast authentication in future operations.

After the identity is authenticated, the user may select an operation such as signing an electronic contract, transferring an electronic contract and executing an electronic contract. The user may be required to input contents of an electronic contract draft, such as commodity code, amount, price and purchasing and selling. When the user completes the operation, the data stream encryption and decryption device (103) encrypts the electronic contract information along with the user identity information. The encrypted information is then transmitted to the user interface (10) via the WAN (22), and is decrypted by the data stream encryption and decryption device (103). The decrypted result is compared with the corresponding information saved in the security authentication device (104) and then authenticated by the security authentication device (104). When user identity authentication is completed, the user interface (10) transmits the electronic contract signature information to the transaction server (15) via internal link.

The network interface system (151) of the transaction server (15) transmits information of signing the electronic contract received from the user interface to the deposit management unit (157) to determine the amount of funds required for signing the electronic contract. The transaction server (15) may derive user's fund information from the data server (18) according to user ID. The deposit management unit (157) may determine if the user has sufficient funds in his/her account which may cover the amount of funds required for signing the electronic contract. If the user's account has sufficient amount of funds, a control signal may be sent to the user terminal device (19) via the user interface (10) to generate a window for user to determine an execution of the electronic contract. If the user decides to sign the electronic contract, the user terminal device (19) may generate a confirmation signal and send the confirmation signal to the transaction server (15) via the user interface (10). The deposit management unit (157) may send the information of signing the electronic contract to the queue sorter (153) waiting for transaction. While waiting in the queue, the transaction matching system (155) may match the contracts based on price. The lower price, the higher priority of being picked up and matched. If more than two contracts comprise the lowest price, the transaction matching system (155) may match the contracts based on the time the contracts enter into the queue. The earlier of being put in the queue, the higher priority of being picked up and matched. When two or more contracts are matched, the transaction result may be sent to the data server (18) via the internal network. The amount of funds for covering the execution of the electronic contract may be deducted from the retained funds. The numbers of matched contracts may be added to the record of the retained user contract account, so as to update data in the data server (18). The procedure of electronic contract signature is completed.

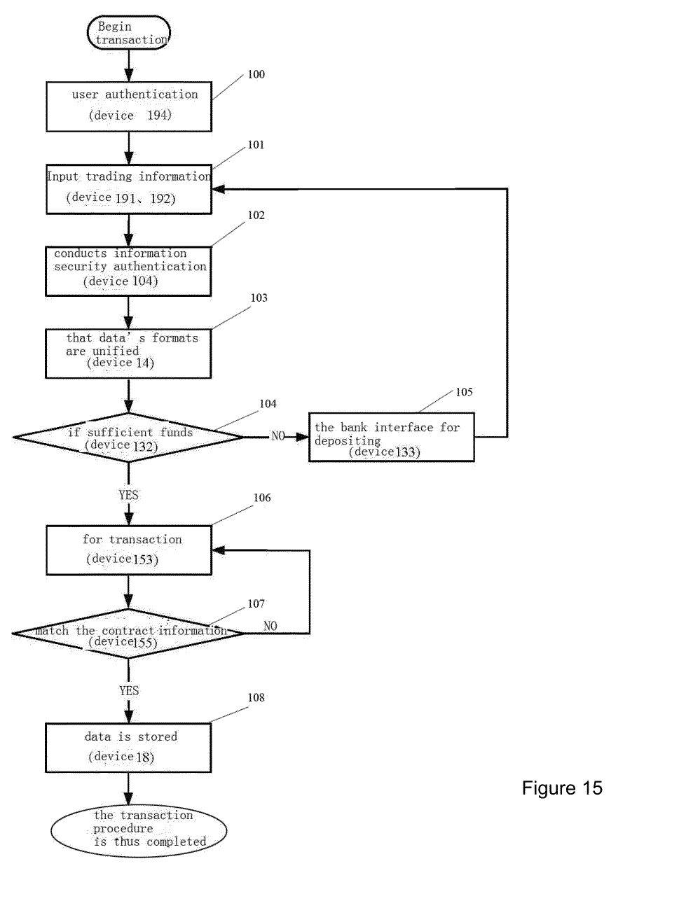

FIG. 15 is a flow chart illustrating an electronic contract signature in a spot transaction system in accordance with exemplary embodiments of the disclosure. When the user terminal device (19) is in operation, the user ID and password may be required. The identity management device (194) exchanges information with the user interface for authenticating user identity (step 100). After successful identity authentication, trading information may be queried and submitted via the input device (191) of an end device (step 101). A user may obtain a commodity catalog from the commodity catalog system (176) and input commodity code, amount, price and selling and buying. The security authentication device (104) then conducts information security authentication and manage security of the communication link in WAN environment to improve seriousness, fairness and legality of each transaction (step 102). After successful security authentication, information may be converted into XML format via the common data channel (14) to unify data's formats, and may be associated with user's bank information or the like (step 103). After successful data format unification, the deposit management unit (157) may determine the amount of funds required for executing the transaction according to deposit of the transaction. Because the deposit is a predetermined percentage of the amount of payment, the user funds information query device (132) may determine if the user has sufficient funds required for transaction information (step 104) in his/her account. If the result obtained at step 104 is NO, the user is directed to a bank interface for more money (step 105). Transaction information may be re-entered (step 101); if the result obtained at step 104 is YES, user information is put in the queue sorter (153) waiting for transaction (step 106). While waiting in the queue, the transaction matching system (155) may match the contracts based on price (step 107). The lower price, the higher priority of being picked up and matched. If more than two contracts comprise the lowest price, the transaction matching system (155) may match the contracts based on the time the contracts enter into the queue. The earlier of being put in the queue, the higher priority of being picked up and matched. When one or more contracts are matched, the transaction result may be sent to the data server (18) (step 108). Then the transaction procedure is completed.

The following chart demonstrates the dynamic procedure of matching signed electronic contracts waiting in the queue:

A transaction matching queue in the transaction matching system (155) for a certain cargo is listed below:

Purchasing

| Price | Amount |
|---|---|
| (Yuan) | (Hands) |
| 4199 | 10 |
| 4198 | 15 |
| 4197 | 5 |
| 4196 | 7 |

Selling

| | Price | Amount |
|---|---|---|
| customer | (Yuan) | (Hands) |
| A | 4201 | 8 |
| | 4202 | 5 |
| | 4205 | 15 |
| | 4207 | 27 |

There are two or more selling actions:

1. Customer A: Action: Selling; Time: 09:59; Amount: 8 Price: 4201

At this time, the system receives a new transaction request via a user end in transaction:

2. Customer B: Action: Selling Time: 10:00 Amount: 5 Price: 4200

3. Customer C: Action: Selling Time: 10:01 Amount: 5 Price: 4201

The selling requests from B and C are inserted into the queue. The table is sorted by price as shown below:

Purchasing

| Price | Amount |
|---|---|
| (Yuan) | (Hands) |
| 4199 | 10 |
| 4198 | 15 |
| 4197 | 5 |
| 4196 | 7 |

Selling

| | Price | Amount |
|---|---|---|
| customer | (Yuan) | (Hands) |
| B | 4200 | 5 |
| A | 4201 | 8 (A) |
| C | | 5 (C) |
| | 4202 | 5 |
| | 4205 | 15 |
| | 4207 | 27 |

The system receives 2 transaction requests from user terminal devices:

The 1^{st} transaction request:

Customer D: Action: Purchasing Time: 10:02 Amount: 3 Price: 4201. Three contracts may be deducted from B's contracts and yield the following result:

Purchasing

| Price | Amount |
|---|---|
| (Yuan) | (Hands) |
| 4199 | 10 |
| 4198 | 15 |
| 4197 | 5 |
| 4196 | 7 |

Selling

| | Price | Amount |
|---|---|---|
| | (Yuan) | (Hands) |
| B | 4200 | 5→2 |
| A | 4201 | 8 (A) |
| C | | 5 (C) |
| | 4202 | 5 |
| | 4205 | 15 |
| | 4207 | 27 |

For customer D: purchased 3 hands successfully

For customer B: sold 3 hands successfully, 2 hands are pending

If the system receives another two transaction requests from the user terminal devices:

The 2^{nd} transaction request:

Customer E: Action: Purchasing Time: 10:03 Amount: 5 Price: 4201

Purchasing

| Price | Amount |
|---|---|
| (Yuan) | (Hands) |
| 4199 | 10 |
| 4198 | 15 |
| 4197 | 5 |
| 4196 | 7 |

| | Selling | |
|---|---|---|
| | Price | Amount |
| customer | (Yuan) | (Hands) |
| B | 4200 | 2→0 |
| A | 4201 | 8→5 (A) |
| C | | 5 (C) |
| | 4202 | 5 |
| | 4205 | 15 |
| | 4207 | 27 |

Transactions performed by customer E may obtain following results:

Customer E: purchased 5 hands successfully

Customer B: sold 2 hands successfully. All customer B's transactions are traded and no pending transactions.

Customer A: sold 3 hands successfully. 5 hands are remained and are pending at 4201 Yuan.

Customer C: No transaction made (entered into the queue later than customer A resulting in lower time priority). 5 hands are remained and are pending at 4201 Yuan.

Embodiment of Electronic Contract Signature:

Spot traders A and B enter market for spot transaction. Trader A is one of the purchasers and Trader B is one of the sellers. The trading product is hot-rolled coil with a trading code BRC.

Trader A retrieves the commodity catalog and inputs the product's trading code BRC at the trading price 4200 Yuan, with a trading amount of 100 tons, and trading behavior is purchasing. The quoting activity is put in the purchasing queue of a purchasing list of the transaction matching unit (155). Trader A does not hold any electronic contract before an execution of a transaction.

Trader B inputs the product's trading code BRC at a trading price 4200 Yuan/ton. Trading amount is 200 tons. Trading behavior is selling. The quoting activity is put in the selling queue of a selling list of the transaction matching unit (155). Trader B does not hold any electronic contract before a transaction.

The transaction matching unit (155) may compare selling and purchasing requests and determine that Trader B's trading price and amount meet trader A's purchasing requests. After the successful match, Trader A holds a standard purchasing contract for 100 tons and Trader B holds a standard selling contract for 100 tons in. At this moment, traders A and B each of which has a contract in hand. Trader B's remained 100 tons are still listed in the selling queue.

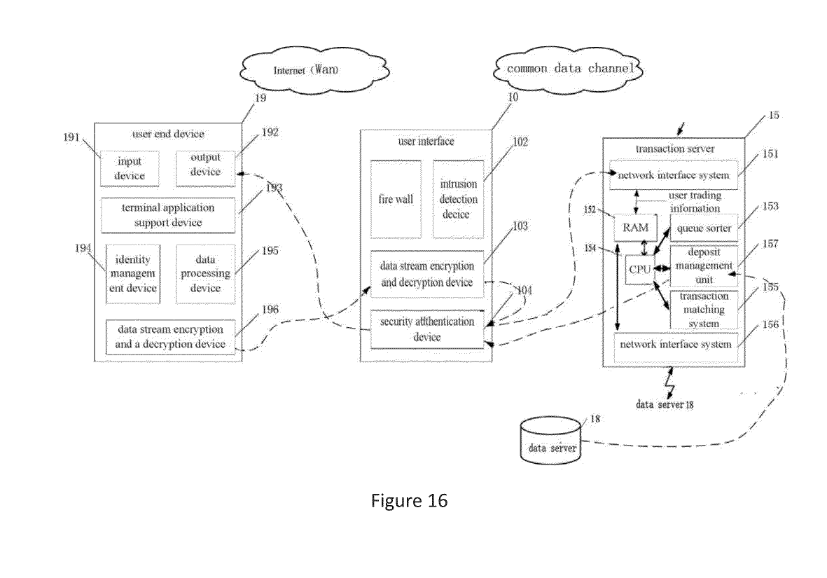

FIG. 16 is a data flow chart illustrating an electronic contract transfer in a spot transaction system in accordance with exemplary embodiments of the disclosure.

After identity authentication, the user may select one operation from available operations such as signing electronic contract, transferring electronic contract and executing electronic contract. In this embodiment, the user may select the content of an electronic contract to be transferred, such as selecting a signed electronic contract, commodity amount, and price. When the user finishes the operation, the data stream encryption and decryption device (196) encrypts the electronic contract transfer information along with the user identity information. The encrypted information is then transmitted to the user interface (10) via the WAN (22), and is decrypted by the data stream encryption and decryption device (103). The security authentication device (104) may conduct a fast authentication on the decrypted result. When the security authentication device (104) receives the information from the user terminal device, compares the user ID code in the user's communication link in WAN with the information saved in the security authentication device (104). When user identity is authenticated, the user interface (10) transmits the electronic contract transfer information to the transaction server (15) via internal link.

The network interface system (151) of the transaction server (15) transmits information of signing the electronic contract received from the user interface to the deposit management unit (157) to determine the amount of funds required for signing the electronic contract. The transaction server (15) may derive user's fund information from the data server (18) according to user ID. The deposit management unit (157) may determine if the user has sufficient funds in his account which may cover the amount of funds required for signing the electronic contract. If the user's account has sufficient amount of funds, a control signal may be sent to the user terminal device (19) via the user interface (10) to generate a window for user to determine an execution of the electronic contract. If the user decides to sign the electronic contract, the user terminal device (19) may generate a confirmation signal and send the confirmation signal to the transaction server (15) via the user interface (10). The deposit management unit (157) may send the information of signing the electronic contract to the queue sorter (153) waiting for transaction. While waiting in the queue, the transaction matching system (155) may match the contracts based on price. The lower price, the higher priority of being picked up and matched. If more than two contracts comprise the lowest price, the transaction matching system (155) may match the contracts based on the time the contracts enter into the queue. The earlier of being put in the queue, the higher priority of being picked up and matched. When two or more contracts are matched, the transaction result may be sent to the data server (18) via the internal network. The amount of funds for covering the execution of the electronic contract may be deducted from the retained funds. The numbers of matched contracts may be added to the record of the retained user contract account, so as to update data in the data server (18). The procedure of electronic contract signature is completed.

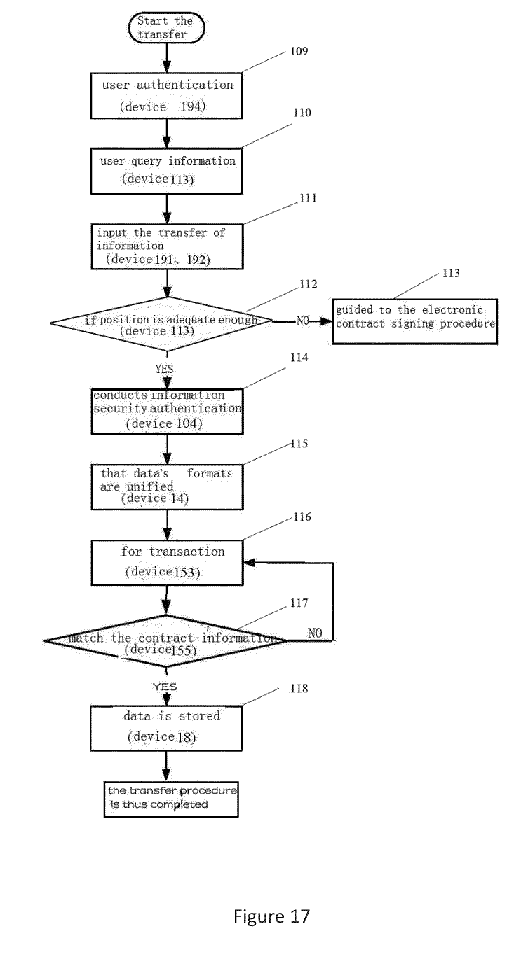

FIG. 17 is a flow chart illustrating an electronic contract transfer in a spot transaction system in accordance with exemplary embodiments of the disclosure. When the user terminal device (19) is in operation, the user ID and password may be required. The identity management device (194) exchanges information with the user interface for authenticating user identity (step 109). After successful identity authentication, the user query information device (113) enables user to check information such as open interest and funds, etc. (step 110). Then transfer information may be submitted via an input device (191) of a user terminal device (step 111). The user may input commodity code, amount, price and the type of trading behavior for the commodity to be transferred such as selling or purchasing. The user query information device (113) may determine if a user holds sufficient deposit required for transfer information in his/her account (step 112). If the result obtained by the user query information device (113) at step 111 is NO, the user is directed to the electronic contract signing procedure (step 113). If the result obtained at step 111 is YES, the security authentication device (114) then conducts information security authentication and manage security of the communication link in WAN environment to improve seriousness, fairness and legality of each transaction (step 114). After successful security authentication, information may be converted into XML format via the common data channel (14) to unify data's formats, and may be associated with user's bank information or the like (step 115). After successful data format unification, user transfer information may be put in the queue sorter (153) waiting for transaction (step 116). While waiting in the queue, the transaction matching system (155) may match the contracts based on price (step 117). The lower price, the higher priority of being picked up and matched. If more than two contracts comprise the lowest price, the transaction matching system (155) may match the contracts based on the time the contracts enter into the queue. The earlier of being put in the queue, the higher priority of being picked up and matched. When two or more contracts are matched, the transaction result may be sent to the data server (18) (step 118). Then the transaction procedure is completed.

Embodiment of Electronic Contract Transfer:

Referring back to “Embodiment of Electronic Contract Signature.” When marketing is rising, the transaction price may go up to 4300 Yuan/ton. If trader A decides to make a transfer contract of 50 tons in the market and finds himself holds a standard contract of 100 tons via the user end query. Then he inputs BRC as a trading code, 4300 Yuan for trading price, 50 tons for trading amount, and trading type is selling. If the transaction matching system (155) finds a buyer who inputs BRC as a trading code and wants to make a purchase at price of 4300 Yuan with 50 tons, the contract of 50 tons is transferred. Trader A still holds 50 tons purchasing contract.

Similarly, if a market is going down, the price may go down, for example, to 4100 Yuan/ton. Trader B holds a selling contract of 100 tons and decides to sell a contract of 50 tons. Trader B may input BRC as a trading code, 4100 Yuan for trading price, 50 tons for trading amount, and trading type is purchasing. If the transaction matching system (155) finds a seller who inputs BRC as a trading code and wants to sell at price of 4300 Yuan with 50 tons, the contract of 50 tons is transferred. Trader B still holds 50 tons selling contract.

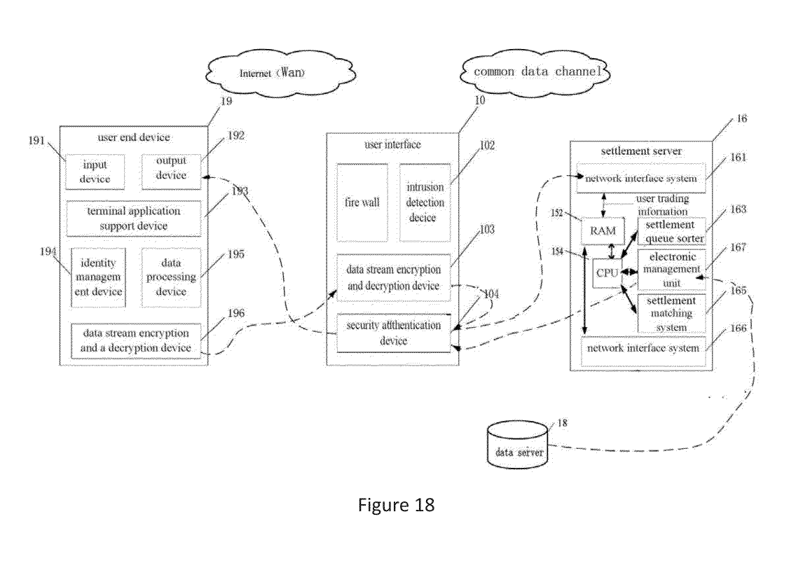

FIG. 18 is a flow chart illustrating an electronic contract in a spot transaction system in accordance with exemplary embodiments of the disclosure.

After identity authentication, the user may select one operation from available operations such as signing electronic contract, transferring electronic contract and executing electronic contract. In this embodiment, the user may select the content of an electronic contract to be transferred, such as selecting a signed electronic contract, commodity amount, and price. When the user finishes the operation, the data stream encryption and decryption device (196) encrypts the electronic contract transfer information along with the user identity information. The encrypted information is then transmitted to the user interface (10) via the WAN (22), and is decrypted by the data stream encryption and decryption device (103). The security authentication device (104) may conduct a fast authentication on the decrypted result. When the security authentication device (104) receives the information from the user terminal device, compares the user ID code in the user's communication link in WAN with the information saved in the security authentication device (104). When user identity is authenticated, the user interface (10) transmits the electronic contract transfer information to the settlement server (16) via internal link.

The network interface system (161) of the settlement server (16) transmits the electronic contract performance information from the user interface to the electronic settlement unit (167) to determine the amount of funds required for signing the electronic contract. The transaction server (15) may derive user's fund information from the data server (18) according to user ID. The electronic settlement unit (167) may determine if the user has the contract required for the electronic contract performance in his/her contract account. If the user has sufficient number of the required contracts, a control signal may be sent to the user terminal device (19) via the user interface (10) to generate a window for user to determine an execution of the electronic contract. If the user decides to sign the electronic contract, the user terminal device (19) may generate a confirmation signal and send the confirmation signal to the settlement server (16) via the user interface (10). The electronic settlement unit (167) of the settlement server (16) may send the information of performance of the electronic contract to the settlement queue sorter (163) waiting for transaction. While waiting in the queue, the settlement matching system (165) may find match the contract information based on the time the contracts enter into the queue. The earlier of being put in the queue, the higher priority of being picked up and matched. When one or more contracts are matched, the transaction result may be sent to the data server (18) via the internal network. The electronic settlement unit (167) may determine the amount of funds and processes the transaction.

If the transaction has been executed, an amount of payment may be deducted from the buyer's funds account and added to the seller's funds account. The number of matched contracts may be deducted from the user's contract account which may update the user's contract account. The procedure of electronic contract performance is completed.

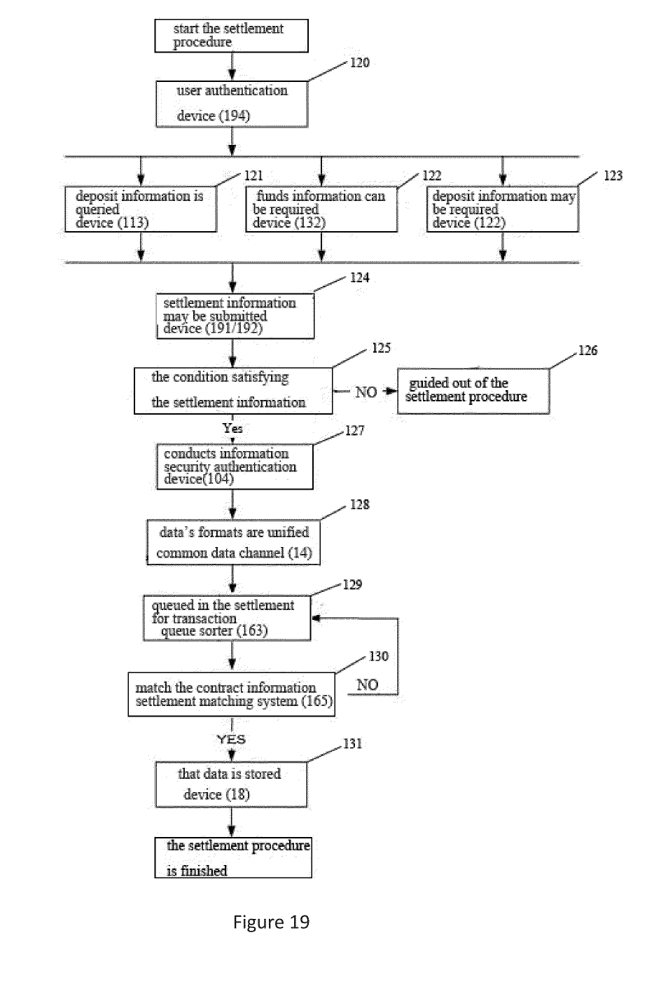

FIG. 19 is a flow chart illustrating an electronic contract performance in a spot transaction system in accordance with exemplary embodiments of the disclosure. When the user terminal device (19) is in operation, the user ID and password may be required. The identity management device (194) exchanges information with the user interface for authenticating user identity (step 120). After successful identity authentication, the user query information device (113) enables user to check contract information of the user's account (step 121). The user funds information query device (132) may check user funds information (step 122). The user storage information query device (122) may check user deposit information (step 123). Settlement information may be submitted via an input device (191) of a user terminal device (step 124). The user is required to input commodity code and amount. The user query information device (113), the user funds query device (132) and the user storage information query device (122) may determine if the user's account information satisfies conditions required by the settlement (step 125). If the result obtained at step 116 is NO, the user is taken out of the settlement procedure (step 126) for supplementing cargo or funds. If the result obtained at step 117 is YES, the security authentication device (104) then conducts information security authentication and manage security of the communication link in WAN environment to improve seriousness, fairness and legality of each transaction (step 127). After successful security authentication, information may be converted into XML format via the common data channel (14) to unify data's formats, and may be associated with user's bank information or the like (step 128). After successful data format unification, user performance information may be put in the settlement queue sorter (163) waiting for transaction (step 129). While waiting in the queue, the settlement matching system (165) may match the contracts (step 130). When one or more contracts are matched, the transaction result may be sent to the data server (18) (step 131). Then the transaction procedure is completed.

Embodiment of Electronic Contract Performance

In settlement stage, if trader A wants to conduct a transaction comprising a contract of 50 tons, trader A may get contract information from his/her account. When trader A confirms that there is a standard purchasing contract of 50 tons in the account trader A may input BRC as trading code and 50 tons for a settlement amount. The settlement may be conducted within a time period of a day or cross two or more days. If trader A's request is matched in the settlement matching unit, the procedure enters the supply chain. The transaction in the system may be completed.

If trader B wants to settle the remained contract of 50 tons he may input BRC as a trading code and 50 tons for settlement amount. The settlement may be conducted within a time period of a day or cross two or more days. If trader B's request is matched in the settlement matching unit, the procedure enters the supply chain. The transaction in the system may be completed.

During the entire transaction conducted by trader A, trader A purchased 100 tons of hot-rolled coils at price of 4200 Yuan/Ton. Trader A sold 50 tons at price of 4300 Yuan/ton and hold 50 tons purchased at price of 4200 Yuan/ton.

During the entire transaction conducted by trader B, trader B sold 100 tons of hot-rolled coils at price of 4200 Yuan/ton. Among the 100 tons, the first 50 tons were purchased at price of 4100 Yuan/ton and the second 50 tons are sold at price of 4200 Yuan/ton.

If trader A's purchasing request is not satisfied, namely, trader A wants to purchase contracts more than those provided by sellers, trader A may get compensation from sellers who did not submit all the BRC selling contracts.

Similarly, if trader B's selling request is not satisfied, namely, trader B wants to sell contracts more than those purchased by buyers, trader B may get compensation from buyers who did not submit all the BRC purchasing contracts.

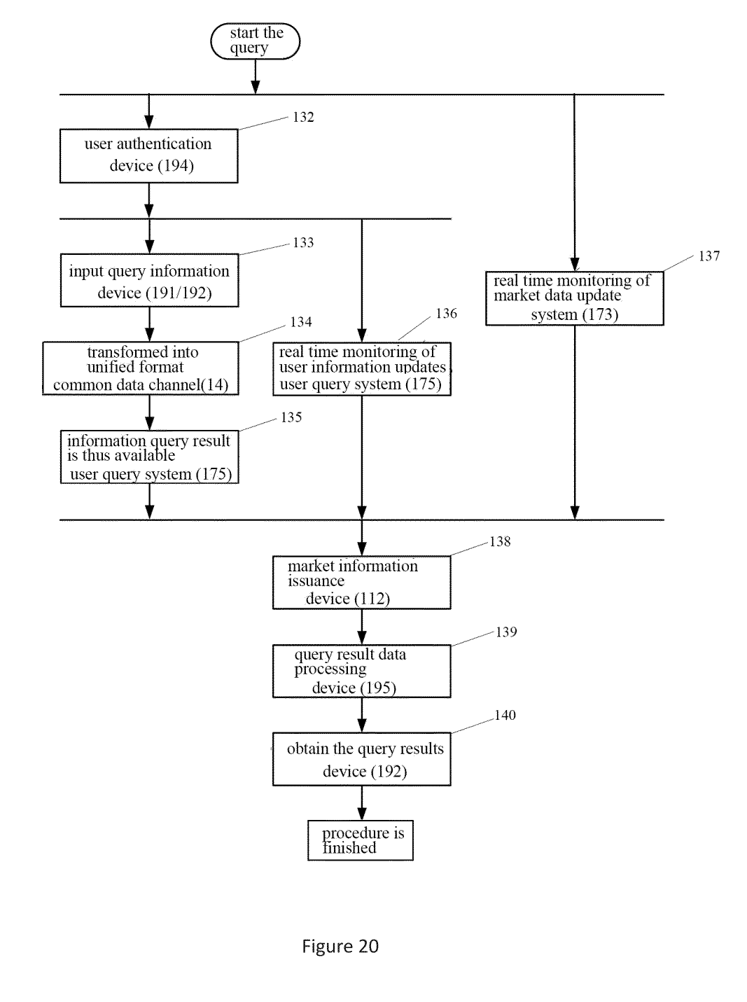

FIG. 20 is a flow chart illustrating query steps in a spot transaction system in accordance with exemplary embodiments of the disclosure.

The query procedure may comprise two situations. Situation one: a user may desire to acquire, query or check profile and/or private information. When the user terminal device (19) is in operation, the user ID and password may be required. The identity management device (194) exchanges information with the user interface for authenticating user identity (step 132). After successful identity authentication, either user or system may be able to initiate a query to check user's profile or private information. If user initiates the query, query information may be submitted via the input device (191) of an end device (step 133). The submitted query information may be converted into XML format via the common data channel (14) to unify data's formats (step 134). After successful data format unification, the user query system (175) may acquire user profile and/or private information (step 135). If the system initiates the query, the user query system (175) may real-timely monitor updates of user profile and/or private information (step 136).

Situation 2: a user may desire to acquire, query or check general market information. When the user terminal device (19) is in operation, the most recent market data may be acquired by real time monitoring and updating market data by the market information issuance system (173) (step 137).

The query results obtained at steps 121, 122 and 123 may be transmitted by the market information issuance device (112) to the user terminal device (19) via WAN (22) (step 138). The data processing device (195) may process the received query results for transmission (step 139). The query results obtained at step 125 may be displayed via the output device (192). The user may obtain the query results from the output device (192) (step 140). Thus the transfer procedure is completed.

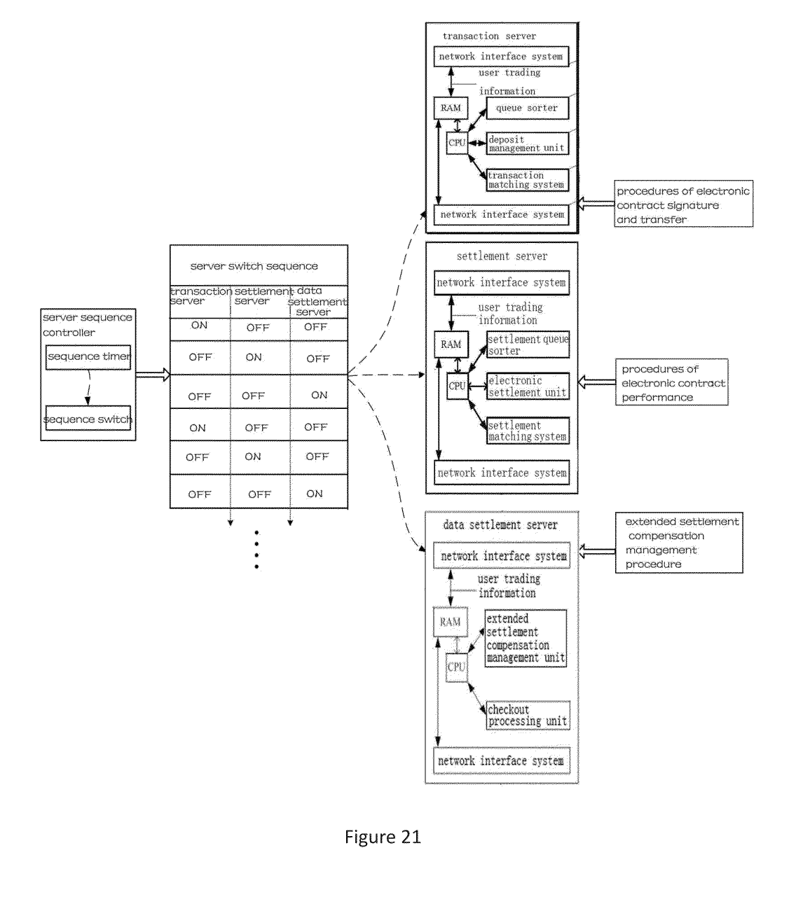

FIG. 21 is a schematic diagram illustrating implementing a spot transaction by a server sequence controller in accordance with exemplary embodiments of the disclosure.

Procedures of spot transaction implemented by the server sequence controller are explained below. It should be understood that the following description is an exemplary embodiment of the devices and the system. The devices may be disposed in different manners for implementing a control method.

The control method may comprise two implementation stages. In the first implementation stage, the server sequence controller (22) may send control signals to control operation of the transaction server (15), the settlement server (16) and the data settlement server (23). For example, the sequence switch (222) may turn on the transaction server (15) and turn off the settlement server (16) and the data settlement server (23). The transaction server (15) may process signing the electronic contract procedure and transferring the electronic contract procedure.

The network interface system (151) of the transaction server (15) transmits information of signing the electronic contract received from the user interface to the deposit management unit (157) to determine the amount of funds required for signing the electronic contract. The deposit management unit (157) may put the electronic contract that meets certain conditions in the queue sorter (153), waiting in the queue for transaction. While waiting in the queue, the transaction matching system (155) may match the contracts based on price. The lower price, the higher priority of being picked up and matched. If more than two contracts comprise the lowest price, the transaction matching system (155) may match the contracts based on the time the contracts enter into the queue. The earlier of being put in the queue, the higher priority of being picked up and matched. When two or more contracts are matched, the transaction result may be sent to the data server (18) via the internal network. The amount of funds for covering the execution of the electronic contract may be deducted from the retained funds. The numbers of matched contracts may be added to the record of the retained user contract account, so as to update data in the data server (18). The procedure of electronic contract signature is completed.

When the transaction method proceeds to the first transaction stage, the server sequence controller (22) may generate a control signal and send the control signal to control operation status of servers. The sequence switch (222) may turn on the transaction server (15) and turn off the settlement server (16) and the data settlement server (23). The transaction server (15) may process signing the electronic contract procedure and transferring the electronic contract procedure.

The network interface system (151) of the transaction server (15) transmits information of signing the electronic contract received from the user interface to the deposit management unit (157) to determine the amount of funds required for signing the electronic contract. The transaction server (15) may the contract that meets certain conditions to the queue sorter (153) waiting for transaction. While waiting in the queue, the transaction matching system (155) may match the contracts based on price and time that the contracts enter into the queue. When two or more contracts are matched, the transaction result may be sent to the data server (18) via the internal network. The amount of funds for covering the execution of the electronic contract may be deducted from the retained funds. The numbers of matched contracts may be added to the record of the retained user contract account, so as to update data in the data server (18). The procedure of electronic contract signature is completed.

When the method proceeds to the second transaction stage, the server sequence controller (22) may generate a control signal and send the control signal to control operation status of servers. The sequence switch (222) may turn off the transaction server (15) and the data settlement server (23), and turn on the settlement server (16). The settlement server (16) may process executing the electronic contract procedure.

The network interface system (161) of the settlement server (16) transmits the electronic contract performance information from the user interface to the electronic settlement unit (167) to determine the amount of funds required for signing the electronic contract. The electronic settlement unit (167) of the settlement server (16) may send the information of performance of the electronic contract to the settlement queue sorter (163) waiting for transaction. While waiting in the queue, the settlement matching system (165) may find match the contract information based on the time the contracts enter into the queue. When one or more contracts are matched, the transaction result may be sent to the data server (18) via the internal network. The electronic settlement unit (167) may determine the amount of funds and processes the transaction.

The method may then proceed to the third transaction stage. The server sequence controller (22) may generate a control signal and send the control signal to control operation status of servers. The sequence switch (222) may turn on the data settlement server (23) and turn off the settlement server (16). The data settlement server (23) may process settlement of the electronic contract.

The data settlement server (23) may be connected to the database (18). The checkout processing unit (235) may execute electronic contract transactions, determine transaction funds and conduct verification. The extended settlement compensation funds management unit (231) may determine compensation for sellers or buyers. For example, when buyer's purchasing request is not satisfied, namely, the buyer wants to purchase contracts more than those provided by sellers, the buyer may get compensation from sellers who did not submit all of their selling contracts. Similarly, if a seller's selling request is not satisfied, namely, the seller wants to sell contracts more than those purchased by buyers, the seller may get compensation from buyers who did not submit all of their purchasing contracts.

The method may then proceed back to the first stage.

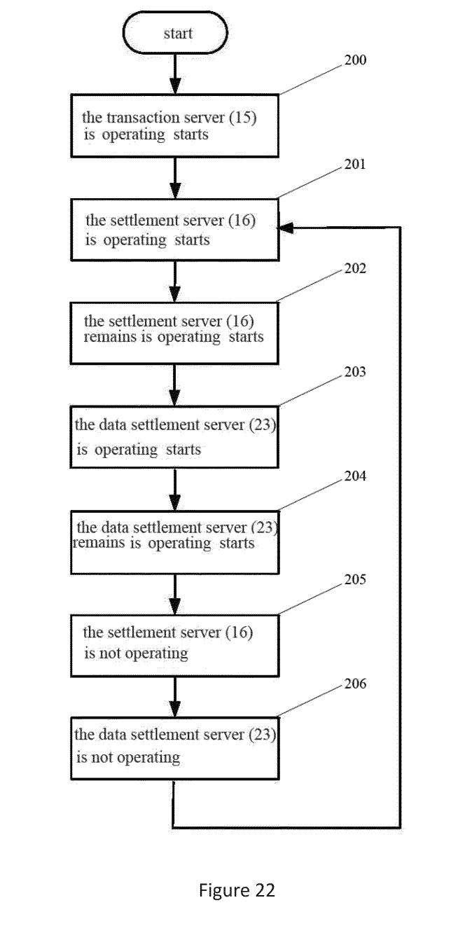

FIG. 22 is a flow chart illustrating running sequence of a server group in a spot transaction system in accordance with exemplary embodiments of the disclosure.

The transaction server (15) is in operating status (step 200). The settlement server (16) is in operating status (step 201). The transaction server (15) remains in operating status. The settlement server (16) remains in operating status (step 202). The data settlement server (23) is in operating status (step 203). The data settlement server (23) remains in operating status (step 204). The settlement server (16) is not in operating status (step 205). The data settlement server (23) is not in operating status (step 206). The method may proceed back to the step 201 to restart the operation.

What is claimed is:

1. An e-commerce system for implementing spot transaction of staple commodities, comprising:
a user-level apparatus comprising a user terminal device (19), a user terminal device (19) configured to input user data, the user terminal device (19) comprising an input device (191) and an identity management device (194);
a transmission level apparatus, comprising a WAN (22) and a private network (23);
an access level apparatus, comprising:
a user interface (10), comprising a security authentication device (104), and
a bank interface (13), comprising a user funds information query device (132) and a user funds operation device (133); and
a service level apparatus, comprising:
a common data channel (14),
a transaction server (15), comprising a deposit management unit (157), a queue sorter (153), and a transaction matching system (155),
an information management server (17), comprising a commodity catalog system (176), and
a data server (18),
wherein one end of the user-level apparatus is coupled to one end of the transmission level apparatus, the other end of the transmission level apparatus is coupled to one end of the access level apparatus, the other end of access level apparatus is coupled to one end of the service level apparatus;
wherein the user terminal device (19) and the user interface (10) are coupled to the WAN (22), and the bank interface (13) is coupled to the private network (23);
wherein the user interface (10), the bank interface (13), the transaction server (15), the information management server (17) are respectively coupled to the data server (18).

2. An e-commerce system for realizing spot transaction of staple commodities, characterized in that the system includes user-level apparatus, transmission level apparatus, access level apparatus and service level apparatus, that one end of the user-level apparatus is connected to one end of the transmission level apparatus whose other end is connected to one end of the access level apparatus whose other end is connected to the service level apparatus;
wherein, the user level apparatus at least includes a user terminal device (19); the transmission level apparatus at least includes a WAN (22); the access level apparatus at least includes a user interface (10) and an information query release interface (11); the service level apparatus at least includes a common data channel (14), a transaction server (15) and a data server (18);
the user terminal device (19), the user interface (10) and the information query release interface (11) are connected to the WAN (22) respectively;
the user interface (10), the information query release interface (11), the transaction server (15) are respectively connected to the common data channel (14);
the transaction server (15) is also connected to the data server (18);
the user terminal device (19) configured to input user data, at least includes an input device (191) and an Identity management device (194);
the user interface (10) at least includes a security authentication device (104);
the information query release interface (11) at least includes a user query information device (113);
the transaction server (15) at least includes a queue sorter (153) and a transaction matching system (155).

3. An e-commerce system for realizing spot transaction of staple commodities, characterized in that the system includes user-level apparatus, transmission level apparatus, access level apparatus and service level apparatus, that one end of the user-level apparatus is connected to one end of the transmission level apparatus whose other end is connected to one end of the access level apparatus whose other end is connected to the service level apparatus;
wherein, the user level apparatus at least includes a user terminal device (19); the transmission level apparatus at least includes a WAN (22) and a private network (23); the access level apparatus at least includes a user interface (10), an information query release interface (11), a storage interface (12) and a bank interface (13); the service level apparatus at least includes a common data channel (14), a settlement server (16) and a data server (18);
the user terminal device (19), the user interface (10), the information query release interface (11) and the storage interface (12) are connected to the WAN (22) respectively; the bank interface (13) is connected to the private network (23);
the user interface (10), the bank interface (13) and the settlement server (16) are respectively connected to the common data channel (14), among which the settlement server (16) is further connected to the data server (18);
the user terminal device (19) configured to input user data, at least includes an input device (191) and an identity management device (194);
the user interface (10) at least includes a security authentication device (104);
the information query release interface (11) at least includes a user query information device (113);
the storage interface (12) at least includes a user storage information query device (122);
the bank interface (13) at least a user funds information query device (132);
the settlement server (16) at least includes a settlement queue sorter (163) and a settlement matching system (165).

4. The system according to claim 1, characterized in that the service level apparatus further includes a data settlement server (23) and a server sequence controller (22) which are respectively connected to the common data channel (14); the server sequence controller (22) manages and controls the working sequence of the transaction server (15), the settlement server (16), the information management server (17) and the data settlement server (23).

5. The system according to claim 1, characterized in that the user terminal device (19) is a computer user terminal device, a mobile phone, a telephone or a combination thereof; the user terminal device (19) may further comprise an end application support means which totally relies on Web technology and is applicable to a plurality of platforms for the support of different ends and different input and/or output devices.

6. The system according to claim 1, characterized in that the identity management device (194) and the security authentication device (104) work together to realize secured communication plan for users in a WAN.

7. The system according to claim 1, characterized in that the user interface (10) receives via the WAN (22) data streams from the user terminal device (19); the user interface (10) further comprises a firewall, an intrusion detection device and data stream encryption and decryption devices, for realization of secured communication process.

8. The system according to claim 2, characterized in that the information query release interface (11) is connected to the WAN (22) and the common data channel (14) so as to realize data stream encryption and decryption, market information release, user information query, market information and user query information distribution and forwarding.

9. The system according to claim 3, characterized in that the storage interface (12) connects to one or a plurality of storage database servers (20) for the fulfillment of data exchange between or among storages; the storage interface (12) comprises a first data conversion means (121) that transmits downward all the data streams received from different storages and converted into an internally unified format, and converts data received from the common data channel into specific data for each and every storage and then transmits the same to the storages.

10. The system according to claim 1, characterized in that the bank interface (13) accesses a private banking network (23) via a telephone line, a sub-network line, a DDN line, an ISDN line or a frame relay line, and connects to at least one banking database server so as to realize data exchange with a bank; the bank interface (13) further comprises a second data conversion means (131) that transmits downward all the data streams accessed from different banks and converted into an internally unified format, converts data received from the common data channel into specific data for each and every bank and then transmits the same to the banks.

11. The system according to claim 1, characterized in that the common data channel (14) converts data received from the data stream of the user interface (10), the bank interface (13) and the storage interface (12) into data with unified XML (Extensible Markup Language) format, so that data exchange among applications can be realized with XML; the common data channel (14) also unifies the data streams received from the user interface (10), the bank interface (13) and the storage interface (12) into unified data streams via mutual management of source data according to their respective ID codes.

12. The system according to claim 1, characterized in that the transaction server (15) particularly comprises a network interface system (151), an RAM (152), a CPU (154), a queue sorter (153), a transaction matching system (155) and a deposit management unit (157); wherein massive trading information is directly processed in the RAM (152) and the computing speed of the transaction server is accelerated by utilizing the principal that the CPU (154) and the RAM (152) exchange information fast, and the deposit management unit (157) processes and calculates a deposit when the two parties of a transaction sign a contract.

13. The system according to claim 1, characterized in that the settlement server (16) includes a network interface system (161), a RAM (162), a CPU (164), a settlement queue sorter (163), a settlement matching system (165) and an electronic settlement unit (167), wherein massive information regarding contract performance is directly processed in the RAM (162) and the computing speed of the transaction server is accelerated by utilizing the principal that the CPU (164) and the RAM (162) exchange information fast, and wherein the electronic settlement unit (167) allocates funds during settlement between two trading parties and processes the status of settlement.

14. The system according to claim 4, characterized in that the data settlement server (23) calculates and checks funds in the system, particularly including a network interface system (231), a RAM (232), a CPU (234), a checkout processing unit (235) and an extended settlement compensation management unit (233); the data settlement server (23) processes the massive accounting data information produced by the transaction server (15) or the settlement server (16) during a certain period.

15. The system according to claim 14, characterized in that the extended settlement compensation management unit (233) calculates, for each transaction subject matter, the amount of compensation for the part of settlement that is not successfully settled for the party who has more application for settlement, on the circumstance that the two parties involved in the settlement respectively apply for different amount of settlement, wherein said compensation is collectively provided by all the traders who have not submitted application for settlement.

16. The system according to claim 4, characterized in that the server sequence controller (22) is respectively connected to the transaction server (15), the settlement server (16), the information management server (17) and the data settlement server (23), so as to realize management and control to the working sequence respectively thereof; the server sequence controller (22) includes a sequence timer (221) and a sequence switch (222), wherein the sequence timer (221) generates accurate server operation sequence period and provides the basis for the sequence switch (222) to send a server status switch signal; the sequence switch (222) process server sequences according to the sequence period and transmits control signals for controlling a server's startup and shutdown.

17. The system according to claim 1, characterized in that the information management server (17) stores a predefined commodity catalog system (176) that is used as a standard electronic contract for transactions, and pushes fast and effectively sequence information regarding the current transaction and settlement and transaction results to the user terminal device (19) and the information query release interface (11); the information management server (17) also includes a user query system (175) which response to a user's query instantly.

18. A method for signing an electronic contract in the system according to claim 1, comprising:
inputting user ID code and secure password when the user terminal device (19) starts up, then the identity management device (194) exchanges information with the user interface (10) and completes user identity authentication;
after successful identity authentication, querying and submitting trading information via the input device (191);
a user obtains a commodity catalog from the commodity catalog system (176) and inputs commodity code, amount, price and the type of trading behavior for the commodity in transaction; the security authentication device (104) then completes information security authentication;
after successful information security authentication, the common data channel (14) unifies the information into XML format, and associates the information with the user's bank information;
when the data format is successfully unified, the deposit management unit (157) calculates the amount required according to a pre-set deposit; then the user funds information query device (132) judges if the user has sufficient funds that meet the need of transaction information.
if the judging result is “NO”, the user is guided to the user funds operation device (133) for funds input operation and to re-enter the trade information;
if the judging result is “YES”, the user transaction information is put in the queue in the queue sorter (153) for transaction;
when queuing for transaction, the transaction matching system (155) matches transactions per the principal of price priority or time priority when the price is equal;
when a transaction is matched, the transaction result is written into the data server (18), so as to realize data storage and complete the transaction.

19. A method for transferring electronic contract in the system according to claim 2, comprising:
inputting user ID code and secure password when the user terminal device (19) starts up; then the identity management device (194) exchanges information with the user interface (10) and completes user identity authentication;
after successful identity authentication, querying a user's position information through the user query information device (113);
after successful position query, submitting the transfer information via the input device (191);
inputting the commodity code, amount and price of the commodity to be transferred; the user query information device (113) judges if the user's position is adequate enough to satisfy the transfer information.
if the calculation result is “No”, the user is guided to the electronic contract signing procedure;
if the judging result is “YES”, the security authentication device (104) conducts information security authentication;
after successful information security authentication, the common data channel (14) unifies data format;
after successful data format unification, the user transfer information queues up in the queue sorter (153) for transaction;
when queuing for transaction, the transaction matching system (155) matches transactions per the principal of price priority and time priority when the price is the same;
when a transaction is matched, the transaction result is written into the data server (18), so as to realize data storage and finish the transaction procedure.

20. A method for the performance of electronic contract in the system according to claim 3, comprising:
inputting user ID code and secure password when the user terminal device (19) starts up; then the identity management device (194) exchanges information with the user interface (10) and completes user identity authentication;
after successful identity authentication, querying user position information through the user query information device (113);
querying a user's funds condition via the user funds information query device (132);
querying a user's storage receipt information through the user storage information query device (122);
after a successful query, submitting settlement information through the input device (191) of the user terminal device (19);
inputting the commodity code and the amount of the commodity to be transferred; the user query information device (113), the user funds information query device (132) and the user storage information query device (122) judge if the user meet the requirement of settlement information;
if the judging result is “No”, the user is guided out of the settlement procedure to supplement cargos or funds.
if the judging result is “YES”, the security authentication device (104) completes information security authentication;
after successful information security authentication, the common data channel (14) unifies data format;
after successful data format unification, the user performance and settlement information queues up in the queue sorter (163) for transaction;
when queuing for transaction, the transaction matching system (165) matches user settlement transactions in queue according to time priority;
when a transaction is matched, the transaction result is written into the data server (18), so as to realize data storage and complete the transaction.
